(19) United States
(12) Patent Application Publication
(10) Pub. No.: US 2004/0022915 A1
(43) Pub. Date: Feb. 5, 2004

(54) Method of preparing a food intermediate under a controlled atmosphere

(76) Inventor: James S. Thorson, Scandia, MN (US)

Correspondence Address: GENERAL MILLS, INC., P.O. BOX 1113, MINNEAPOLIS, MN, 55440, US

(21) Appl. No.: 10/209,706

(22) Filed: Aug. 1, 2002

(51) Int. Cl. A21D 10/00

(52) U.S. Cl. 426/549

(57) ABSTRACT

The invention provides a method of mixing dough that includes combining ingredients for the dough in a mixing system that is configured so that the atmosphere therein can be controlled, controlling the atmosphere wherein said controlled atmosphere has at least about 80% nitrogen, and mixing in the controlled atmosphere to form a resulting dough. Also included are methods having the steps of combining ingredients in a mixing system that is configured to be able to control the atmosphere, and having a gas feed supplied by a nitrogen tank, purging the atmosphere of air, controlling the atmosphere so that it includes at least about 90% nitrogen, and mixing the ingredients in the controlled atmosphere to form a resulting dough. The invention also provides improved methods of mixing dough that include combining ingredients for the dough in a mixing system that is configured so that its atmosphere can be controlled, controlling the atmosphere in the mixing system, and mixing the ingredients in the controlled atmosphere to form a resulting dough, wherein the dough or baked products thereof have improved characteristics.

### CROSS-REFERENCES TO RELATED APPLICATIONS

None

### FIELD OF THE INVENTION

The invention generally pertains to a method of preparing a food intermediate. More specifically, the invention pertains to a method of preparing dough that includes blanketing the dough ingredients in a nitrogen rich atmosphere during mixing in order to achieve reduced mixing times, reduced mix energy requirements without loss in quality or appearance.

### BACKGROUND OF THE INVENTION

Food intermediates are used in the preparation of a number of finished food products. Food intermediates typically undergo one or more treatment steps prior to being ready to consume. Such treatment steps may include, baking, cooking or frying, further mixing, blending and the like. Food intermediates as used in this invention include items such as dough, ingredient blends, mixtures, solutions and the like.

Generally, dough that is used in baked goods requires considerable processing before the dough can be baked to result in a final product. Dough processing includes, among other steps, mixing, sheeting and machining. Dough mixing refers to the process wherein individual ingredients (flour, water and possibly other ingredients) are combined together and mixed, generally with a mechanical mixing system. Dough machining refers to the process wherein the mixed dough is formed, or machined into some physical form or sheeted. There are a number of characteristics of dough that contribute to the handling properties of dough. These include extensibility, baked specific volume and dough energy of mixing.

Extensibility of dough is an example of a dough characteristic that is necessary for dough machining. Extensibility is important for a number of reasons. Dough that is highly extensible, that is dough which has good elastic properties generally has improved machinability as it can be easily stretched and the apparatus won't protrude or break through the dough during machining. “Bucky” dough, is a term used to describe a dough that has a low extensibility, shows a high degree of structural resistance to extension, that is it breaks during handling. making further processing extremely difficult. Such a dough is hard to process in that it cannot be manipulated easily and tends to be more costly to complete the processing steps, as more time and potentially more ingredients are needed to finish the creation of the food intermediate or final food product.

A characteristic of dough that relates to dough mixing is the energy of mixing. The energy of mixing refers to the amount of energy that is required to mix dough to a certain defined processing level. The point that the dough is mixed to can be defined using virtually any measurable quality of the dough. One example of a measurable quality used to define the energy of mixing is the extensibility.

Generally speaking, it is desirable to have lower values for energy of mixing. As this allows the mixing to be accomplished more economically. In mass production and processing of dough, the less energy used to prepare such dough is desirable.

A previous method used to produce dough having higher extensibility was to add dough conditioners. Although these conditioners have positive effects on extensibility, they also cause undesirable changes in other characteristics of the dough. For example, a commonly used dough conditioner, L-cysteine, reduces the baked specific volume of the product and causes an unwanted modification in the texture of the product. Often these conditioners cause the overall quality of the baked product to deteriorate and diminish the aesthetic qualities of the baked good, such as discoloration. Furthermore, additional ingredients, such as dough conditioners, often cause concern in consumers because they are unfamiliar with this type of food ingredient or may have an adverse impact on the taste of the dough.

Therefore, there remains a need for a method of increasing dough extensibility and other desirable characteristics without the need for additional processing steps and ingredients.

### SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

In one embodiment of the present invention a method of preparing a food intermediate is described and comprises the steps of initially combining ingredients in a mixing chamber. The mixing chamber is configured so as to be able to create and control the atmosphere in the chamber therein. The atmosphere is created by adding at least a first gas and then controlling the atmosphere to maintain a particular proportion of the first gas. The ingredients in the chamber are then blanketed with at least a first gas. The first gas makes up greater than half of the atmosphere in the chamber. The ingredients are then mixed in the controlled atmosphere to form a resulting food intermediate having improved processing properties. The improved processing properties include reduced mix energy and increased extensibility.

A still further embodiment of the present invention relates to a method of preparing a food intermediate that comprises the steps of, first, combining ingredients for a food intermediate in a mixing chamber which has an atmosphere that can be created and controlled, such as by the purging or pressurizing the chamber. Creating the atmosphere by adding a first and second gas. The controlled atmosphere of the chamber includes a first gas making up at least 80% of the atmosphere and the second gas making up less than 20% of the atmosphere. Finally, the ingredients are mixed in said controlled atmosphere to form a food intermediate having improved extensibility.

A yet still further embodiment of the present invention describes a method of preparing dough and includes the steps of combining ingredients for a dough in a mixing chamber. The mixing chamber has at least a first gas inlet and a gas outlet, and is configured so that an atmosphere therein can be created and controlled. The atmosphere of the chamber is purged of air. Next, nitrogen is added to the mixing chamber to create an atmosphere having at least about 80% nitrogen. The ingredients in the chamber are then blanketed by the nitrogen and finally, the ingredients are mixed in the atmosphere to form a resulting dough having reduced mix energy requirements.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts is a schematic of a dough mixing system for use with a method of the invention;

FIG. 2 is a graph displaying the average time to the farinograph peak versus the percent oxygen in the mixing atmosphere for a yeast leavened dough;

FIG. 3 is a graph displaying the average height of the farinograph peak versus the percent oxygen in the mixing atmosphere for a yeast leavened dough; samples with NUBAKE™ and L-cysteine and uncontrolled atmosphere are also shown;

FIG. 4 is a graph of immediate extensibility versus percent oxygen for a yeast leavened before-peak dough (270 sec), at-peak dough (390 sec), and past-peak dough (510 sec);

FIG. 5 is a graph of extensibility after a rest time of 15 minutes versus percent oxygen for a yeast leavened before-peak dough (270 sec), at-peak dough (390 sec), and past-peak dough (510 sec);

FIG. 6 is a graph of average baked specific volume versus percent oxygen for a yeast leavened before-peak dough (270 sec), at-peak dough (390 sec), and past-peak dough (510 sec);

FIG. 7 is a graph displaying the average time to the farinograph peak versus the percent oxygen in the mixing atmosphere for a chemically leavened dough;

FIG. 8 is a graph displaying the height of the first and second peak in the farinograph versus the percent oxygen in the mixing atmosphere for a chemically leavened dough;

FIG. 9 is a graph of immediate extensibility versus percent oxygen for a chemically leavened before-peak dough (90 sec), at-peak dough (150 sec), and past-peak dough (240 sec);

FIG. 10 is a graph of extensibility after a rest time of 15 minutes versus percent oxygen for a chemically leavened before-peak dough (90 sec), at-peak dough (150 sec), and past-peak dough (240 sec);

FIG. 11 is a graph of average baked specific volume versus percent oxygen for a chemically leavened before-peak dough (90 sec), at-peak dough (150 sec), and past-peak dough (240 sec);

FIG. 12 is a graph of immediate extensibilities versus time of mixing for a yeast leavened dough, mixed under a non-controlled atmosphere with no dough conditioner, mixed under a non-controlled atmosphere with L-cysteine, and mixed under 100% nitrogen atmosphere with no dough conditioner;

FIG. 13 is a graph of extensibility after a rest time of 15 minutes versus time of mixing for a yeast leavened dough mixed under a non-controlled atmosphere with no dough conditioner, mixed under a non-controlled atmosphere with L-cysteine, and mixed under 100% nitrogen atmosphere with no dough conditioner; and

FIG. 14 is a graph of average baked specific volume versus time of mixing for a yeast leavened dough mixed under a non-controlled atmosphere with no dough conditioner, mixed under a non-controlled atmosphere with L-cysteine, and mixed under 100% nitrogen atmosphere with no dough conditioner;

### DETAILED DESCRIPTION OF THE PREFERRED EMBODIMENT

1. Dough Formulations

Methods in accordance with the invention can be used to make a variety of food intermediates such as refrigerated doughs including doughs for breads, such as French bread, wheat bread, white bread, corn bread, rolls, such as cinnamon rolls, dinner rolls, caramel rolls and other assorted baked goods such as breadsticks, croissants, pastries, biscuits, pizza dough, and the like. Additionally, the invention can be used to make non-refrigerated doughs, such as doughs that are immediately baked or doughs made from dry mixes. Virtually any dough can be mixed using a method of the invention.

Because certain dough characteristics are more important in some doughs than in others, in one embodiment, a method of the invention will be more advantageously used in certain varieties of doughs. For example, dough extensibility is more important in developed doughs than in undeveloped doughs. Developed doughs are those in which the protein network has been more or less fully formed or created. Examples of developed doughs include dough for breads or rolls. Undeveloped doughs are those in which the protein network is not yet fully formed. Examples of undeveloped doughs include but are not limited to biscuit dough for example. Therefore, in one embodiment a method of the invention is used with developed doughs, such as bread or roll dough.

Dough formulations, and the ingredients they contain, can differ depending on the finished product the dough is to be used for. However, most doughs generally have a number of ingredients in common, examples of some such common ingredients are described and illustrated in more detail below.

A. Flour

The dough of the invention generally contains a grain constituent that contributes to the structure of the dough. Different grain constituents lend different texture, taste and appearance to a baked good. Flour is the most commonly used grain constituent in baked goods, and in most baked foods is the primary ingredient.

Suitable flours include hard wheat flour, soft wheat flour, corn flour, high amylose flour, low amylose flour, and the like. For example, a dough product made with a hard wheat flour will have a more coarse texture than a dough made with a soft wheat flour due to the presence of a higher amount of gluten in hard wheat flour.

Bread flours are primarily milled from hard red winter or spring wheats. Generally these flours have a protein content of about 11.0-12.5%. Certain baked products may require stronger bread flours with about 1-2% higher protein content.

In breadmaking, flour may comprise up to about 95% of the ingredients (excluding water). In bread, when the flour comes in contact with water, and the ingredients are mixed, the gluten protein fraction forms elastic, gas-retaining films.

B. Leavening Agents

The doughs of the invention also generally include leavening agents that increase the volume and alter the texture of the final baked good. Such leavening agents can either be chemical leavening agents or yeast.

Chemical leavening typically involves the interaction of at least one leavening acid and at least one leavening base. The leavening acid generally triggers the release of carbon dioxide from the leavening base upon contact with moisture. The carbon dioxide gas aerates the dough or batter during mixing and baking to provide a light, porous cell structure, fine grain, and a texture with a desirable appearance and palatability.

The evolution of carbon dioxide essentially follows the stoichiometry of typical acid-base reactions. The amount of leavening base present determines the amount of carbon dioxide evolved, whereas the type of leavening acid affects the speed at which the carbon dioxide is liberated. The amount of leavening base used in combination with the leavening acid can be balanced such that a minimum of unchanged reactants remain in the finished product. An excess amount of leavening base can impart a bitter flavor to the final product, while excess leavening acid can make the baked product tart.

Sodium bicarbonate, or baking soda, a leavening base, is the primary source of carbon dioxide gas in many chemical-leavening systems. This compound is stable and relatively inexpensive to produce. Other leavening bases include for example potassium bicarbonate, ammonium carbonate and ammonium bicarbonate.

Leavening bases can be modified in order to alter the way in which they work. For example, they can be encapsulated. Encapsulated leavening bases, such as encapsulated baking soda, will tend to delay the onset of the leavening reaction because the encapsulating material must dissolve before the leavening reaction can occur.

Generally, the method of the invention can utilize modified or non-modified leavening bases as part of a chemical leavening system. Specifically, however, one embodiment of the invention utilizes non-encapsulated leavening bases as part of the chemical leavening system.

Leavening acids include sodium or calcium salts of ortho, pyro, and complex phosphoric acids in which at least two active hydrogen ions are attached to the molecule. Baking acids include compounds such as monocalcium phosphate monohydrate (MCP), monocalcium phosphate anhydrous (AMCP), sodium acid pyrophosphate (SAPP), sodium aluminum phosphate (SALP), dicalcium phosphate dehydrate (DPD), dicalcium phosphate (DCP), sodium aluminum sulfate (SAS), glucono-delta-lactone (GDL), and potassium hydrogen tartrate (cream of tartar).

Yeast is also utilized for leavening baked goods, and is often preferred because of the desirable flavor it imparts to the dough. Bakers' yeast is supplied in three forms: yeast cream, a thick suspension with about 17% solids; a moist press cake with about 30% solids; and an active dry yeast, with about 93 to 98% solids. Generally, active dry yeasts of acceptable quality have been available for some time, and recently instant active dry yeast has also been available for commercial use.

The quantity of yeast added to dough is directly related to the time required for fermentation, and the form of the yeast utilized. Generally, most bread doughs are made with from about 2 to 3% fresh compressed yeast, based on the amount of flour.

Methods of the invention can be used with either chemical or yeast leavened doughs.

C. Additional Ingredients

The dough of the invention can also contain additional ingredients. Some such additional ingredients can be used to modify the texture of dough. Texture modifying agents can improve many properties of the dough, such as viscoelastic properties, plasticity, or dough development. Examples of texture modifying agents include fats, emulsifiers, hydrocolloids, and the like.

Shortening helps to improve the volume, grain and texture of the final product. Shortening also has a tenderizing effect and improves overall palatability and flavor of a baked good. Either natural shortenings, animal or vegetable, or synthetic shortenings can be used. Generally, shortening is comprised of triglycerides, fats and fatty oils made predominantly of triesters of glycerol with fatty acids. Fats and fatty oils useful in producing shortening include cotton seed oil, ground nut oil, soybean oil, sunflower oil, rapeseed oil, sesame oil, olive oil, corn oil, safflower oil, palm oil, palm kernel oil, coconut oil, or combinations thereof.

Emulsifiers include nonionic, anionic, and/or cationic surfactants that can be used to influence the texture and homogeneity of a dough mixture, increase dough stability, improve eating quality, and prolong palatability. Emulsifiers include compounds such as lecithin, mono- and diglycerides of fatty acids, propylene glycol mono- and diesters of fatty acids, glyceryl-lacto esters of fatty acids, and ethoxylated mono- and diglycerides.

Hydrocolloids are added to dough formulations to increase moisture content, and to improve viscoelastic properties of the dough and the crumb texture of the final product. Hydrocolloids function both by stabilizing small air cells within the batter and by binding to moisture within the dough. Hydrocolloids include compounds such as xanthan gum, guar gum, and locust bean gum.

Although the invention is meant to replace the use of dough conditioners for purposes such as increasing the extensibility or decreasing the energy of mixing for the dough, certain embodiments may also include dough conditioners which may or may not be used to have the same effect.

Dough-developing agents can also be added to the system to increase dough viscosity, texture and plasticity. Any number of agents known to those of skill in the art may be used including azodicarbonamide, diacetyl tartaric acid ester of mono- and diglycerides (D.A.T.E.M.) and potassium sorbate.

Another example of a dough-developing additive is PROTASE™. PROTASE™ is a proprietary product containing enzymes and other dough conditioners. PROTASE™ is generally used to reduce mixing time and improve machinability. PROTASE 2X™, a double strength version can be commercially obtained from J. R. Short Milling Co., Chicago, Ill.

Dough conditioners are also examples of dough additives. One example of a dough conditioner is NUBAKE™, commercially available from RIBUS (St. Louis, Mo.). Another example of a dough conditioner is L-cysteine, commercially available from B. F. Goodrich (Cincinnati, Ohio).

Dough can also frequently contain nutritional supplements such as vitamins, minerals and proteins, for example. Examples of specific nutritional supplements include thiamin, riboflavin, niacin, iron, calcium, or mixtures thereof.

Dough can also include flavorings such as sweeteners, spices, and specific flavorings such as bread or butter flavoring. Sweeteners include regular and high fructose corn syrup, sucrose (cane or beet sugar), and dextrose, for example. In addition to flavoring the baked good, sweeteners such as sugar can increase the moisture retention of a baked good, thereby increasing its tenderness.

Dough can also include preservatives and mold inhibitors such as sodium salts of propionic or sorbic acids, sodium diacetate, vinegar, monocalcium phosphate, lactic acid and mixtures thereof.

Methods of the invention include the steps of combining ingredients for a dough in a mixing system, configured so that the atmosphere can be controlled, controlling the atmosphere in the mixing system, and mixing the ingredients in the controlled atmosphere to form a resulting dough.

Methods of the invention can be used with any known method of mixing doughs including but not limited to a straight dough method, and a sponge and dough method. Details of a method of the invention can therefore depend in part on the type of dough that is being mixed, and the method of mixing that is generally used with that type of dough. For example, some chemically leavened doughs require a two step process. Methods of the invention can be utilized with two step processes, as well as other types of processes. Methods of the invention can also incorporate varied mixing times. The time a dough is mixed using a method of the invention can depend in part on the type of dough that is being mixed and the general process that is being used.

A. Combining the Ingredients in the Mixing System

Methods of the invention combine the ingredients for the dough in a mixing system configured so that the atmosphere can be controlled.

Generally, the step of combining the ingredients in the mixing system depends on the particular ingredients, the type of dough being mixed, the type of process being used, and the type of mixing system being used. One of skill in the art, having read this specification, would know based on the ingredients being used, the type of process being used, and the type of mixing system being used, and how to accomplish this step.

B. Controlling the Atmosphere in the Mixing System

1. Mixing System

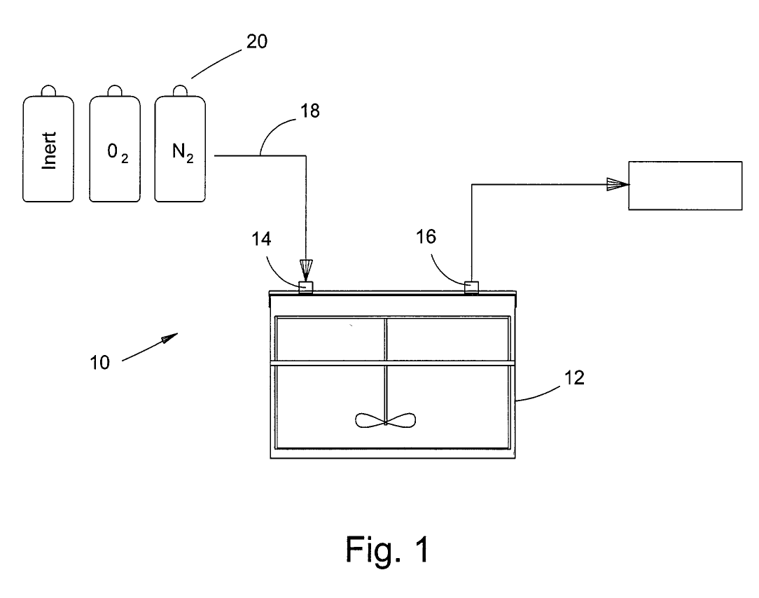

FIG. 1 depicts a mixing system for use in a method of the invention. A mixing system 10 for use in the invention includes a mixing chamber 12, a gas inlet 14, a gas outlet 16 and a gas feed line 18.

As depicted, mixing chamber 12 comprises a container for holding the ingredients and the means for mixing the ingredients. Generally, the means for mixing the ingredients may include any means for mixing that is generally used by those of skill in the art. Examples of such means include horizontal bar mixers, high speed mixers, such as Stephan brand high speed mixers, Hobart bowl mixers and spiral mixers.

Mixing chamber 12 is capable of being sealed to the atmosphere. When the mixing chamber 12 is closed, the only significant openings to the outer atmosphere are provided by gas inlet 14 and gas outlet 16.

Sealed to the atmosphere, in the context of mixing chamber 12 means that there is no significant uncontrolled contact with the atmosphere outside the mixing chamber. Sealed to the atmosphere, in this context, does not mean that there is no contact with the atmosphere outside the mixing chamber 12. Some level of contact with the atmosphere outside mixing chamber 12 can be compensated for by increasing the pressure of the controlled atmosphere within mixing chamber 12.

Mixing system 10 also includes at least one gas inlet 14. Gas inlet 14 allows gas to be fed into mixing chamber 12. Gas inlet 14 can alternatively be equipped with a means for controlling the amount of gas allowed into mixing chamber 12, a means for measuring the pressure within the mixing chamber 12 or combinations thereof. As mentioned above, the contact of the mixing chamber 12 with the outside atmosphere can be controlled in part by controlling the pressure within mixing chamber 12. This can be accomplished through manipulation of gas inlet 14.

Gas feed 18 functions along with gas inlet 14 to provide a means by which gas can be added to mixing chamber 12. Gas feed 18 works with a supply of gas 20 to allow gas to be fed into mixing chamber 12 through gas inlet 14. The supply of gas 20 for gas feed 18 can include a single tank of gas, multiple tanks of gas of which the contents can be the same or different, some other supply of gas (such as a chemical reaction), the atmosphere, or combinations thereof.

In one embodiment of the invention, gas feed 18 has at least one supply of gas 20. In another embodiment of the invention, gas feed 18 has at least one tank of gas as a supply of gas 20. In another embodiment, at least one tank of gas comprises nitrogen gas. In yet another embodiment of the invention, gas feed 18 is supplied by at least two tanks of gas, at least one of those comprising nitrogen and at least one comprising oxygen. Alternatively, gas feed 18 could be supplied by at least one tank of nitrogen and a source of air. Air, as used herein, refers to the atmosphere outside mixing system 10, which generally comprises at least nitrogen and oxygen, and is largely uncontrolled.

In yet another embodiment, a third supply of gas may be utilized. The third supply may contain other inert gases that are slightly soluble in doughs can be utilized. The solubility of the gas in the dough is important in order to effectuate rising of the dough. If the gas is too soluble in the dough, it will dissolve instead of forming bubbles. It is these bubbles enclosed within the dough that effectuates rising. Examples of such inert gases include but are not limited to helium, neon, or argon. In another embodiment carbon dioxide could also be used as a supply for gas feed 18. In one embodiment the moisture content of the gas supply is controlled.

Mixing system 10 also includes gas outlet 16. Gas outlet 16 functions to remove gas from mixing chamber 12. Gas outlet 16 can be configured to allow gas to passively leave mixing chamber 12, be forced from mixing chamber 12, to remain in mixing chamber 12, or a combination thereof. Gas outlet 16 can alternatively be equipped with means for measuring the pressure within the mixing chamber 12.

Gas outlet 16 can be used to purge gas from mixing chamber 12 before the mixing is begun, to purge excess gas added during mixing, to maintain mixing chamber 12 under the desired atmosphere, to control the relative amounts of different kinds of gas within mixing chamber 12, or some combination thereof. Gas outlet 16 can be used in concert with gas inlet 14 or can be used alone. Purging the mixing system of air means to force gas that is present in mixing system 10 from the mixing system 10. Purging the mixing system can be accomplished by forcing another gas into mixing system 10, pulling the gas in mixing system 10 from mixing system 10 with a vacuum pump or similar device, or combinations thereof for example.

Mixing chamber 12, gas inlet 14, gas feed 18, and gas outlet 16 function together to allow for mixing of ingredients within mixing chamber 12 under a controlled atmosphere. Components of the mixing system 10 can control the atmosphere within mixing system 10, the atmosphere within mixing chamber 12, or combinations thereof. A mixing system 10 for use in the invention includes mixing systems that are commercially available with at least the components enumerated above, as well as mixing systems that can be modified to contain the components enumerated above.

An example of a commercially available mixing system that is capable of controlling the atmosphere includes mixers such as, for example, the Oshikiri Model HM50 (Oshikiri Machinery Ltd., Tokyo, Japan).

2. Controlling the Atmosphere

“Controlling the atmosphere” includes controlling the atmosphere in mixing system 10, controlling the atmosphere above mixing chamber 12, or controlling the atmosphere of mixing within chamber 12. “Controlling the atmosphere” also includes controlling and/or modifying the identities of gases in the atmosphere, controlling and/or modifying the ratios of gases in the atmosphere, controlling and/or modifying the overall amount of gas in the atmosphere, controlling and/or modifying the partial pressures of gases in the atmosphere, or combinations thereof.

Controlling the atmosphere can be accomplished by any means known to one of skill in the art. For example, gas could be allowed to enter the mixing chamber 12, gas could be forced into mixing chamber 12, gas could be allowed to exit the mixing chamber 12, gas could be forced out of mixing chamber 12, or combinations thereof.

Generally, methods of the invention control the atmosphere so that desired gases either are or are not present. Alternatively, the atmosphere can be controlled to provide at least 99% of one gas. As recited above, the gas can be supplied from a tank, from the air, from a chemical reaction, or from another source of gas (such as for example liquid nitrogen or dry ice (solid carbon dioxide)). In one embodiment, the atmosphere is controlled to provide a desired ratio of two different gases. In another embodiment, the atmosphere is controlled to provide a desired ratio of nitrogen to oxygen gas (or conversely oxygen to nitrogen gas). In another embodiment, the atmosphere is controlled to provide a desired ratio of nitrogen to air (or conversely air to nitrogen). In yet another embodiment, the atmosphere is controlled to provide at least about 99% nitrogen, this is also referred to as nitrogen blanketing. Alternatively, a ratio can be expressed in other terms such as percentages, partial pressures, volumes, or flow rates, for example.

In one embodiment of the invention, flow rates are used to control the ratio of gases. This can be accomplished by accomplishing the ratio of the flow rates of two or more gases. For example, a ratio of about 100:0 of N₂:air requires the ratio of the flow rates of N₂ to air to be infinite. As another example, a 90:10 ratio of N₂:air requires a ratio of flow rates of N₂ to air of about 1 to 1, or about 90 to 10 of N₂ to O₂. The overall sum of the flow rates is not critical. In one embodiment of the invention, the total flow rate is enough to ensure positive pressure within the mixing system.

In one embodiment of the invention the atmosphere is controlled so that in the ratio of nitrogen to oxygen gas, the nitrogen makes up greater than half of the atmosphere and ranges from about 100:0 to 60:40. In another embodiment of the invention, the atmosphere is controlled so that the ratio of nitrogen to oxygen gas ranges from about 100:0 to 80:20. In yet another embodiment of the invention, the atmosphere is controlled so that the ratio of nitrogen to oxygen about 100:0 to 90:10. In even yet another embodiment of the invention, the atmosphere is controlled so that the ratio of nitrogen to oxygen is about 99:1.

3. Resulting Dough

Dough that is mixed using a method of the invention can have improved characteristics as compared to the same dough mixed without using a method of the invention. Examples of such characteristics include extensibility of the dough, baked characteristics of the dough, and the energy of mixing.

A. Extensibility

Extensibility is the degree to which a dough product can be extended before it breaks. An extensigraph is a load-extension instrument that is designed to provide empirical measurements of the extensibility of the dough. Extensigraphs are commonly used for studying flour quality and the effect of certain additives on bread baking.

One method of measuring the extensibility of a dough that has been mixed is to weigh the dough, mold it into a cylinder shape, and clamp it at both ends in a special cradle of One method of measuring the extensibility of a dough that has been the extensigraph machine. After an optional rest period, the dough is stretched using a hook that moves at a constant rate of speed. The dough is stretched, through its midpoint, and then until it ruptures or breaks.

The result of this test is a load (resistance) versus extension curve, commonly called an extensigram. Much useful information can be obtained from an extensigram. The measurements most commonly obtained from an extensigram are, the maximum resistance, Rₘ, which is determined by the maximum height of the curve, the resistance at an extension of about 5 cm, R₅, and the total curve length in centimeters (at what length the dough breaks). The R values of these measurements are generally given in arbitrary units of resistance called Brabender units. The total area under the curve is also often calculated and reported in square centimeters.

The maximum height of the curve, and the area under the curve are indicative of the strength of the dough. Larger values of the area or the maximum curve height indicate a stronger dough while smaller values indicate a weaker dough. The overall shape of an extensigram can give an estimate of the dough's viscoelastic balance, with long, low curves having a predominance of viscosity over elasticity.

The length that the dough stretches before it breaks is called the extensibility of the dough. Bread or roll doughs generally have extensibility values between about 170 and 240 mm. Doughs for biscuits and cakes generally have an extensibility of at least about 160 mm.

Because extensigrams provide information on the strength of the dough, they can provide information about how changes in dough ingredients or mixing conditions can change the properties of the dough. Extensibility measurements can be used to determine the effects of a number of things, including but not limited to proteolytic enzymes, various oxidizing or reducing agents, and methods of mixing the ingredients into a dough.

Doughs mixed using a method of the invention often have different extensibilities than doughs mixed without using a method of the invention. Such doughs can have improved extensibilities as compared to doughs mixed without using a method of the invention. Generally speaking, improved extensibility means a higher value of extensibility. Doughs, especially yeast leavened doughs, mixed using a method of the invention can have higher extensibilities than those mixed without using a method of the invention.

B. Baked Characteristics of Dough

One of the most important characteristics of a baked product is the product's baked specific volume (“BSV”). The BSV of a product relates the volume of the baked product to the weight of the product. Generally, products with higher BSVs are lighter and have more gas or air incorporated therein. Products with lower BSVs are heavy, dense and generally undesirable in developed doughs.

BSV can be measured using commonplace displacement methods. One example of a method commonly used is the rapeseed method. In this method, a baked product of a known mass is placed in a container containing a known and measurable volume of rapeseed. Once the baked product is placed in the container containing the baked product, the volume of the rapeseed and baked product is measured. The specific volume of the baked product is then determined by dividing the volume of the baked product by the mass of the baked product.

Generally, BSV is reported in ml/g developed dough products such as baked breads and rolls generally have BSVs of from about 4 ml/g to 7 ml/g. Dough products, such as baked breads and rolls generally have improved BSVs. Improved BSVs can refer to higher values of BSV or similar values of BSV obtained with a shorter mixing time for the dough. In one embodiment, methods of the invention provide baked goods with BSVs similar to doughs that were mixed for a longer period of time.

C. Energy of Mixing

Doughs mixed using a method of the invention often require less energy to reach a given level of mixing. The energy and time necessary for mixing a dough that is to be used in a commercially manufactured product is often one of the rate limiting steps in the manufacturing of the product. Therefore, methods of decreasing the energy needed to mix a dough could have a commercial impact.

The energy of mixing defines the amount of energy necessary to reach a pre-defined level of mixing, often a desired level of extensibility, or time of mixing. The energy of mixing is measured, for example by attaching a device capable of measuring energy, for example a watt meter attached to a mixer. The watts are monitored until the desired level or time of mixing has been met. The area under the curve is then integrated to obtain the value for the energy of mixing. Values for energy of mixing will be based on the specific amount of dough being mixed.

The amount of energy necessary for mixing depends on a number of factors, including the type of dough being made, the flour being used, and the use of dough conditioners, such as oxidizing and reducing agents. Values for energy of mixing can range from about 20 to 60 BTU/lb (about 10 to 30 calories/gram).

Doughs mixed using a method of the invention often have improved energies of mixing. Improved energies of mixing refers to lower values of energy of mixing, or lower values of energy of mixing to obtain another characteristic of the dough, such as a desired extensibility or BSV determined by monitoring values of extensibility or other characteristics for example.

D. Changes in Dough Characteristics

When dough is mixed using a method of the invention, certain characteristics of the dough including those discussed above, can be changed. These changes could be due to a number of factors, and although it is not relied upon, the following represents possible explanations for changes that may be seen in doughs mixed using a method of the invention.

One key factor in dough development, rheology, and baked product quality is the formation of the protein network of the dough. When flour is hydrated during the mixing process, protein molecules polymerize, forming long chains of protein molecules. With vigorous mixing action, these chains begin to break, fold over one another, and cross-link to create an interwoven entanglement.

This interwoven entangled structure is thought to be important for a number of reasons. First, the formation and subsequent breakdown of this structure causes dough to exhibit a peak in the curve of instantaneous power versus time. Curves such as these are used in monitoring the development of the dough.

The peak in the instantaneous power versus time curve is believed to relate to BSV. Generally, a dough that is mixed until it reaches the peak in the instantaneous power versus time curve has a high BSV and good product quality. However, doughs that reach this peak and have desirable values of BSV and product quality may still have low extensibilities and be hard to process. This interwoven matrix is also important because it allows the dough to retain gas bubbles even after proofing and baking. A highly cross-linked and well formed matrix structure is strong and able to withstand the expansion of these bubbles during baking. This leads to a product with a fine gas cell structure, and consequently a fine crumb structure. If the matrix is not well cross-linked it is weak and tears under the tensile strain of the expanding gas bubbles, forming large pockets in the bread.

One factor in controlling this interwoven entangled protein network is the oxidation state of the dough. As the oxidation state of the dough is decreased, less cross-linking occurs. A less cross-linked network tends to form longer and more aligned chains ultimately leading to a more highly elastic and extensible dough. On the other hand, raising the oxidation state of the dough increases the amount of cross-linking. This creates a very strong and highly entangled structure. This type of structure ultimately produces a dough with higher structural recovery, lower elasticity, and lower extensibility. Also, because the network is stronger, it is better able to withstand the expansion of gas bubbles within the structure and forms fewer large gas pockets in the final product.

The controlled atmosphere used in methods of the invention are thought to control the oxidation state of the dough. In one embodiment of a method of the invention some or all of the oxygen present in the mixing atmosphere is replaced with nitrogen. With less oxygen in contact with the dough during mixing, a dough with a lower oxidation state will likely be obtained. Therefore, the dough should be more elastic.

Another factor, which can have an affect on the quality of a baked product is bubble nucleation in the dough. Methods of the invention are also thought to alter the quality of the baked product by altering bubble nucleation. Because oxygen and carbon dioxide are highly soluble in dough, they go into solution easily and do not form bubbles during mixing. Nitrogen, on the other hand, has a lower solubility and therefore remains insoluble in the dough and forms small bubbles during mixing. Mixing acts to break these bubbles down even further into small nucleation sites. As the dough leavens, the carbon dioxide produced saturates the dough and is forced out of solution. The nucleation sites, the pre-existing nitrogen bubbles, act as sites for bubble growth, causing the product to be more fully leavened.

### WORKING EXAMPLES

The following examples provide a nonlimiting illustration of the application and possible benefits of the invention.

Small Scale System for Mixing

Small scale testing was done in a farinograph, with recipes scaled down to about 480 grams. The mixing chamber was sealed at all edges and fitted with a tube for gas delivery. The top of the chamber was sealed with duct tape. Holes, equipped with flaps, were made in two opposite corners and in the center. The opposite cornered holes were used for gas delivery and release as well as water addition. The center hole was used for addition of ingredients after mixing was begun. The center hole was normally sealed. The edges around the cover and mixing chamber were sealed using non-toxic food grade grease (Haynes Lubri-Film, Haynes Manufacturing Co., Westlake, Ohio). The quality of chamber isolation was tested by feeding a sufficient flow rate of gas to create a slight positive pressure and then spraying water around the edges to check for bubbles formed by leaking gas.

Gas (to create a nitrogen rich atmosphere) was injected at a total rate of about 1250 ml/min, corresponding to two mean residence times per minute, and was metered using two Cole-Palmer gas flow meters. Gas was fed to the flow controllers at about 5 psig from cylinders, using appropriate regulators. A tube size of 0.25 inches (0.64 cm) outer diameter was used with easy fit connectors. To minimize any drying effects caused by the gas flow, the gas was saturated with moisture by passage through a water sparge. This was done using a 2000 mL Erlenmeyer flask with a fish tank sparge.

Bagel Dough Formulation

The dough formulation utilized in this example was a basic yeast leavened bagel dough. Three different conditions were used: mixing with nitrogen blanketing, mixing without nitrogen blanketing, and with about 3750 ppm PROTASE™ 2X (R. Short Milling Co., Chicago, Ill.), but without nitrogen blanketing. The dough mixed with PROTASE™ RX was included in the experiment to compare the effects of a method of mixing dough according to the invention and a standard dough conditioner.

The ingredients for a basic yeast leavened bagel dough were placed into a HM50 model Oshikiri horizontal bar mixer. The minimum gap between the bar and the wall, the mixing gap, was 15 mm.

The basic bagel dough mixed without nitrogen, and the basic bagel dough with PROTASE™ 2X were mixed using a standard method of mixing. The basic bagel dough mixed with nitrogen blanketing was mixed by first putting the ingredients in the mixer, and purging the system of air for 4 to 5 minutes. Nitrogen gas was then added to the system through the gas inlet, and the flow was maintained at a constant flow of about 0.06 f³/sec (2 liters/sec), while allowing nitrogen to bleed out of the system.

Specific characteristics of the resulting dough were observed and measured to determine the effects of nitrogen blanketing on dough mixing. The dough mixed with nitrogen blanketing appeared very smooth, had a uniform appearance, and was subjectively extensible in that it could be stretched to approximately 150 mm without breaking. However, the dough lacked the characteristic smell of the basic bagel dough mixed with a standard method, and had a bland, almost sour smell associated with it.

Dough extensibility, mix time, and total integrated energy input of all three dough formulations were measured. Table 1 below shows the results of these tests.

TABLE 1

| | | | With PROTASE |
|---|---|---|---|
| | Without N₂ | With N₂ | 2× and without |
| | Blanketing | Blanketing | N₂ Blanketing |
| Mix time to 200 mm* | 26 | 16 | 22 |
| extensibility (min) | | | |
| Total Integrated mix energy | 52 | 38 | 41 |
| to 200 mm extensibility | (29) | (21) | (23) |
| Btu/lb (kcal/kg) | | | |

*dough mixed with nitrogen blanketing reached an extensibility of 250-mm, whereas those without nitrogen blanketing reached a maximum extensibility of 200-mm.

By using nitrogen blanketing during mixing, a 250 mm instantaneous dough extensibility was reached after only 16 minutes of mixing. An instantaneous dough extensibility refers to the extensibility of a 150 g sample of dough immediately removed from the mixer and tested in an extensiograph. A time of 16 minutes represented a 40% decrease in mix time as compared to the same dough mixed without nitrogen blanketing, and a 30% decrease as compared to the same dough without nitrogen blanketing but with PROTASE™ 2X. It should also be noted that these two other mixing conditions, without nitrogen blanketing and with PROTASE™ 2X, only reached a maximum extensibility of 200 mm. Therefore, the comparison of mixing time necessary to reach the same extensibility is probably more favorable towards the dough mixed with nitrogen blanketing, than is represented by these comparisons.

Two further extensibility measurements were recorded after the dough mixed with nitrogen blanketing had rested for 3 and 5 minutes respectively, with values for extensibility being 150-mm and 125-mm respectively.

The total integrated energy of the dough mixed with nitrogen blanketing was also compared to the dough mixed without nitrogen blanketing and with PROTASE™ 2X but without nitrogen blanketing. The total integrated energy to reach an extensibility of 250 mm was 38 Btu/lb (21 kcal/kg), which was a 27% decrease from the basic bagel dough formulation mixed without nitrogen blanketing. This also represented a 7.9%/o decrease from the basic bagel dough formulation mixed with PROTASE™ 2X. These comparisons were again based on assuming that the same extensibility was reached, although the dough mixed with nitrogen blanketing had a 250 mm extensibility and the doughs mixed without nitrogen blanketing and with PROTASE™ 2X reached a maximum extensibility of only 200 mm.

A basic yeast leavened dough mixed using a method of the invention showed a 40% decrease in mixing time necessary to reach a comparable extensibility as compared to the same dough mixed using a standard method. A dough mixed using a method of the invention also showed a 30% decrease in mixing time to the same extensibility, and a 7.9% decrease in mixing energy as compared to a dough mixed using PROTASE™ 2X, a common dough conditioner.

Chemically Leavened Dough

In this example, a chemically leavened dough was utilized. Three different conditions were again used: mixed with nitrogen blanketing, mixed without nitrogen blanketing, and with 75 ppm potassium sorbate but without nitrogen blanketing. The dough mixed with sorbate was included in the experiment to compare the effects of a method of mixing dough according to the invention and a standard dough conditioner.

The ingredients for a chemically leavened dough were placed into a HM 50 model Oshikiri horizontal bar mixer (Oshikiri Machinery Ltd., Tokyo, Japan). The mixing gap was set at 15 mm, the mixing temperature was 65° F., and the mixer was set at 85 rotations per minute (rpm).

The chemically leavened dough mixed without nitrogen, and the chemically leavened dough with potassium sorbate were mixed using a standard method. Chemically leavened doughs are generally mixed in two stages.

All three mixing conditions were begun by putting the first stage ingredients in the mixer. During the nitrogen blanketing mixing, the system was then purged for about 4 to 5 minutes. Nitrogen gas was then added to the system through the gas inlet, and the flow was maintained at about 0.07 ft³/sec (2 liters/sec) during mixing. The other two dough formulations were simply mixed without purging or gas flow.

After about 7 minutes of mixing, the second stage ingredients were added. The dough being mixed under nitrogen blanketing was exposed to the outside atmosphere at this time. In all three cases, the dough was mixed for about 13 more minutes.

Specific characteristics of the resulting dough were observed and measured to determine the effects of nitrogen blanketing on dough mixing. The dough mixed with nitrogen blanketing appeared clumpy, was non-uniform in appearance, and had a sour smell.

Dough extensibility and total integrated energy input of all three dough formulations were measured. Table 2 below shows the results of these tests.

TABLE 2

| | | | With 75 ppm |
|---|---|---|---|
| | Without N₂ | With N₂ | potassium sorbate |
| | Blanketing | Blanketing | and without N₂ |
| Extensibility at 20 | 105 | 150 | 135 |
| minutes* mix time (mm) | | | |
| Total Integrated mix | 48 | 44 | 40 |
| energy to 200 mm | (27) | (25) | (22) |
| extensibility Btu/lb | | | |
| (kcal/kg) | | | |

*crusty French loaf mixed without nitrogen blanketing was mixed for 21 minutes to reach the given extensibility

By using nitrogen blanketing during mixing, the dough mixed for 20 minutes had a 30% increase in extensibility from the same dough mixed without nitrogen blanketing (mixed for 21 minutes). The extensibility of the dough mixed with nitrogen blanketing also represented a 10% increase over the extensibility of the dough containing 75 ppm potassium sorbate and mixed without nitrogen blanketing.

The total integrated energy of the dough mixed with nitrogen blanketing was also compared to that of the other doughs. The dough mixed with nitrogen blanketing had a 8% decrease in total integrated energy as compared to the dough mixed without nitrogen blanketing. However, the dough containing potassium sorbate showed a greater decrease in total integrated energy.

Therefore, a chemically leavened dough mixed in accordance with the invention showed increased extensibility at similar mix times and had a decreased energy of mixing.

Nitrogen/Oxygen Concentration

Having determined that nitrogen blanketing can enhance dough extensibility and total mixing energy, the amount of nitrogen was then optimized.

In this example, a yeast leavened submarine sandwich roll dough was utilized. The dough was mixed with varying levels of nitrogen and oxygen present in the blanketing atmosphere. The yeast leavened dough was also mixed with two different dough conditioners, L-cysteine, commercially available from B. F. Goodrich (Cincinnati, Ohio), and NUBAKE™, commercially available from RIBUS (St. Louis, Mo.). The dough mixed with NUBAKE™ was included in the experiment in order to compare the effects of a method of mixing dough according to the invention and a standard dough conditioner.

The dry ingredients for the yeast leavened dough were placed into a farinograph configured to provide a mixing system in accord with the invention (as in Example 1). The dry ingredients were mixed briefly by hand with a spoon. The chamber was then sealed and the system was purged for about 2 minutes using a 1250 ml/min total gas flow to remove air in the headspace. The liquid ingredients (water) were then added through the gas outlet using a funnel. The water was added separately to prevent premature hydration of the flour during the purge step.

The atmosphere in the mixing chamber was varied in order to study the effects of atmospheric content on the dough characteristics. The mixture of nitrogen and oxygen was stepped in 20% segments, therefore the percent of oxygen in the different atmospheres were: 0%, 20%, 40%, 60%, 80%, and 100%. Each oxygen percentage was run twice to obtain average values for the desired measurement.

After the initial steps discussed above were accomplished, and the mixing chamber atmosphere was set to the specified level (one of the ratios above), the dough was mixed for about 10 to 11 minutes.

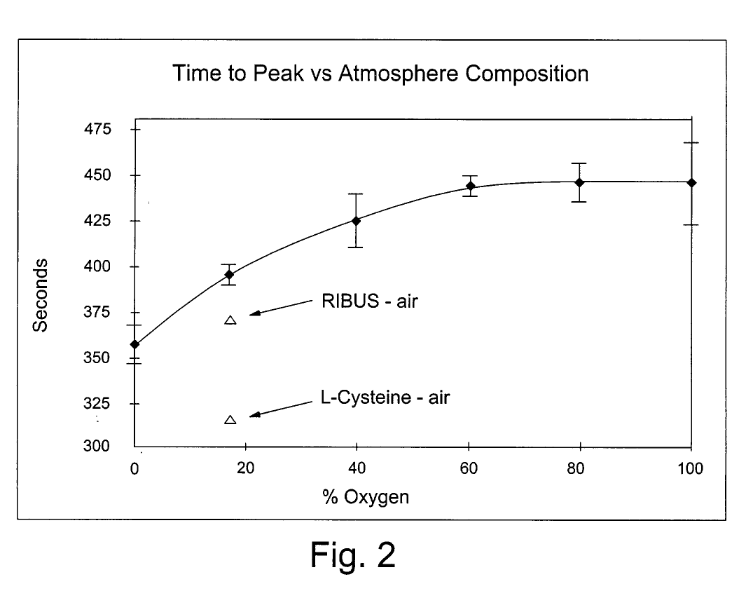

Full farinographs were obtained for each dough. As seen in FIG. 2, a strong correlation was seen between the atmospheric content and the time to the farinograph peak. As oxygen amounts increase, the time to peak increased, following a logarithmic function. There was approximately a 10% decrease in the time it took to reach the peak in the dough mixed in nitrogen compared to that in air with no conditioner. Mixing in air with L-cysteine was found to be more effective in lowering the time to peak than mixing with nitrogen blanketing. The L-cysteine dough reduced the time to peak by 20% compared to that mixed in air with no conditioner. The NUBAKE™ conditioned dough showed a 6% reduction in time to peak. There was not a significant difference in time to peak for oxygen levels greater than 60%.

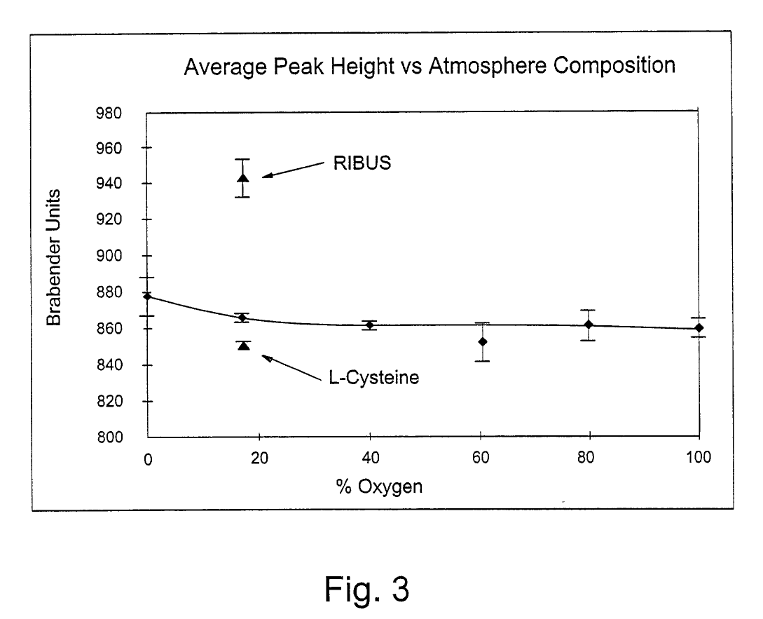

FIG. 3 shows average farinograph peak height versus the % oxygen in the atmosphere. Changes in peak height over the entire atmosphere range were very small with only slight decreases in height occurring with increasing oxygen levels. There also seemed to be a slight decrease in peak definition, a flattening of the farinograph curve as oxygen increased.

This experiment showed that mixing in higher nitrogen levels allows extensibility peaks to be reached quicker. However, the decrease in mixing time was not as pronounced was it was with the dough conditioner L-cysteine.

Changing Mix Times

In this example, mix times were varied slightly (dough temperature of 65° F., mixing speed of 85 rpm and mixing gap of 15 mm) in order to study the effects of atmosphere over a range of dough developments. Mix times were chosen to correspond to before-peak, to-peak, and after-peak as seen in FIG. 2, and obtained in the example above relating to nitrogen/oxygen concentration. For the yeast leavened submarine sandwich roll dough, these times were 4.5 minutes (270 seconds), 6.5 minutes (390 seconds), and 8.5 minutes (510 seconds) respectively. The to-peak time is that of dough mixed in air with no conditioner. Although the 0% O₂ and 40% O₂ mixed dough had slightly different peak times, they were both within about 30 seconds. Because there were negligible differences in peak height or curve shape for the first mixing step over the range of atmospheres observed earlier, this time was not varied.

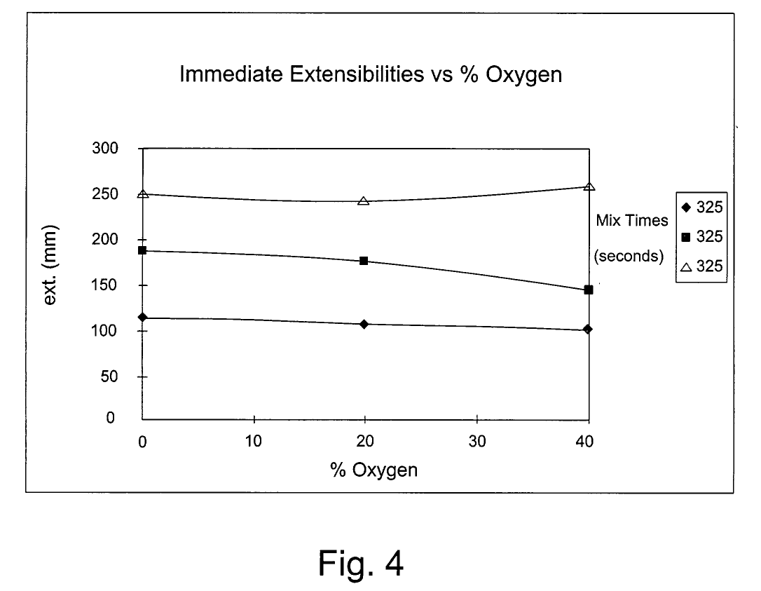

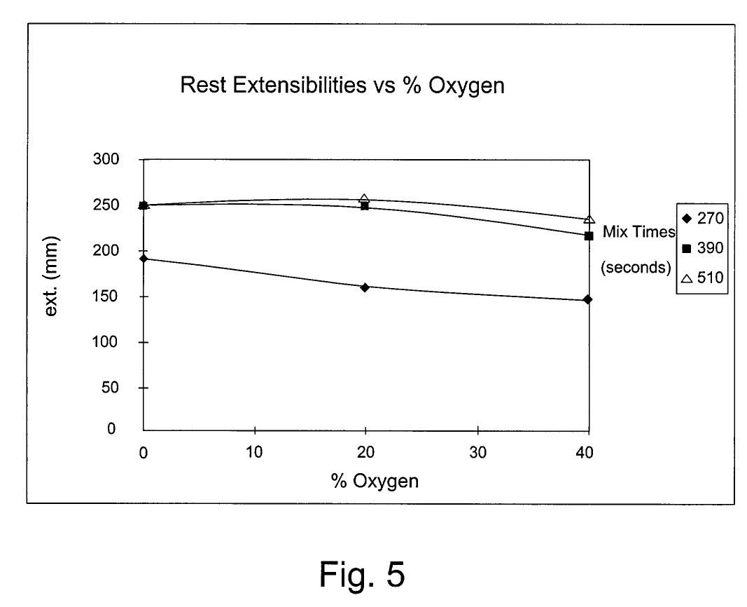

A number of tests were done on the doughs prepared thereby. Upon completion of mixing, the dough was removed from the chamber and two 150 gram samples were cut for extensibility measurements. One of these samples was tested immediately (data seen in FIG. 4), and one was formed, placed in the rest chamber, and allowed to rest for 15 minutes before being tested (data seen in FIG. 5). A sample of about 100 grams, for microscopy, was cut from each trial and immediately frozen. Samples were also tested for formation of the gluten matrix.

As seen in FIGS. 4 and 5, immediate and rest extensibility (seen respectively in FIGS. 4 and 5) tended to increase as oxygen levels decreased. For the before-peak dough, immediate extensibility decreased slightly with decreasing oxygen while rest extensibility showed a more significant reduction. The at-peak dough showed the largest change in immediate extensibility over the atmosphere range with 100% nitrogen showing a 10% increase and 40% 02 showing a 20% decrease compared to air. The past-peak dough was very extensible for all concentrations, and little change was noted. Rest extensibility was very high for the at-peak and past-peak dough; in many cases the extensigraph was unable to break the dough at 250 mm. The nitrogen mixed dough was particularly extensible, and although the maximum measurable extensibility is 250 mm, the actual value is closer to 270 mm.

This experiment showed that mixing under nitrogen increases dough extensibility by about 10% over air and is also more effective than L-cysteine and NUBAKE™.

Baked Products

Three 30 gram samples prepared above were cut and hand-formed into spheres for baking. These samples were frozen, then later thawed, proofed, and baked. The process for this baking included allowing the dough to warm to about 55° to 60° F., then proofing the dough at 95° F. and 85% relative humidity for about an hour. The dough was then baked at about 380° F. for about 15 minutes. The samples were allowed to cool uncovered in air for 30 minutes and placed in plastic bags. Bake specific volumes (“BSV”) were calculated using a standard rapeseed method as discussed previously. Baked samples were sliced to examine the gas cell size & distribution.

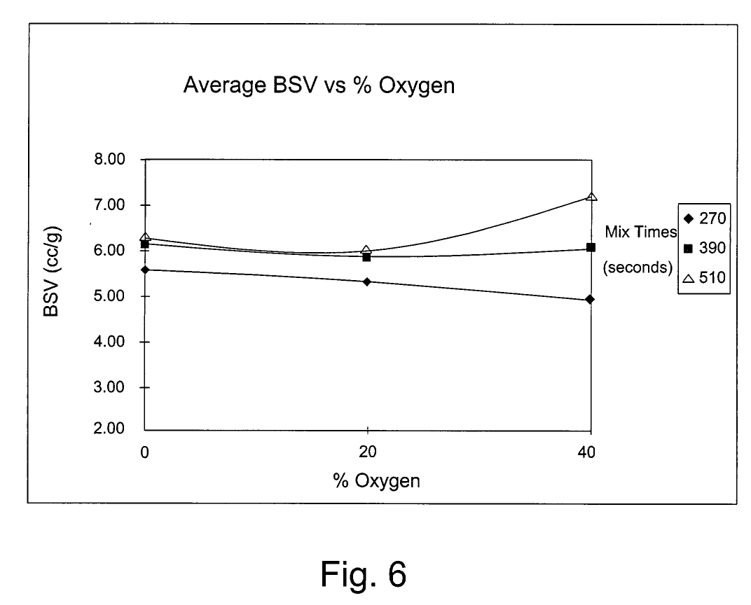

As seen in FIG. 6, the samples showed only small differences in baked specific volume over the range of atmospheric conditions, with the largest difference being for the past-peak samples. This deviation may be found in slight timing differences. Therefore, the samples mixed in the larger amounts of oxygen were past-peak by a lesser degree.

Examination of the quality of the baked product showed that the doughs mixed in a nitrogen atmosphere tended to have a more open gas cell structure than air, and 40% oxygen baked breads tended to have a finer gas cell structure than air. The dough mixed in nitrogen tended to have more large gas pockets, presumably because the weak protein matrix was unable to withstand the tensile stress of the expanding bubbles and therefore ripped, leading to the consolidation of many small bubbles. Nitrogen mixed breads showed a slight yellowish color not found in the other samples. This was seen both on a small and large scale.

This experiment showed that baked goods from doughs mixed using a method of the invention have characteristics comparable with doughs mixed using standard methods. Differences are seen in gas cell structure and coloring, but in most cases are relatively insubstantial.

Chemically Leavened Dough

In this example, a chemically leavened dough was utilized. The dough formulation was mixed with varying levels of nitrogen and oxygen present in the blanketing atmosphere. The chemically leavened dough was also mixed with two different dough conditioners, L-cysteine, commercially available from B. F. Goodrich (Cincinnati, Ohio) and NUBAKE™, commercially available from RIBUS (St. Louis, Mo.).

The dry ingredients for the chemically leavened dough were placed into a farinograph configured to provide a mixing system in accord with the invention and described earlier. The mixing chamber was controlled at a temperature of about 60° F. The dough rested at about 64° F. The dry ingredients, absent the chemical leaveners, the dough conditioners, etc. were mixed briefly by hand with a spoon. The chamber was then sealed and the system was purged for about 2 minutes using a 1250 ml/min total gas flow to remove air in the headspace. The liquid ingredients (water) were then added through the gas outlet using a funnel. The water was added separately in order to prevent premature hydration of the flour during the purge step.

The atmosphere in the mixing chamber was varied in order to study the effects of atmospheric content on the dough characteristics. The mixture of nitrogen and oxygen was stepped in 20% segments, therefore the relative percentage of oxygen present in the different atmospheres were: 0%, 20%, 40%, 60%, 80%, and 100%. Each oxygen percentage was run twice to obtain average values for the desired measurement.

After the initial steps discussed above were finished, and the mixing chamber atmosphere was set to the specified level (one of the ratios above), the dough was mixed for about 5 to 6 minutes.

After this initial mixing time, second stage ingredients were added through a center hole in the mixing chamber using a funnel. It was then mixed for another 4 to 5 minutes. This amount of time was believed to be sufficient for the dough to develop through an over-developed stage.

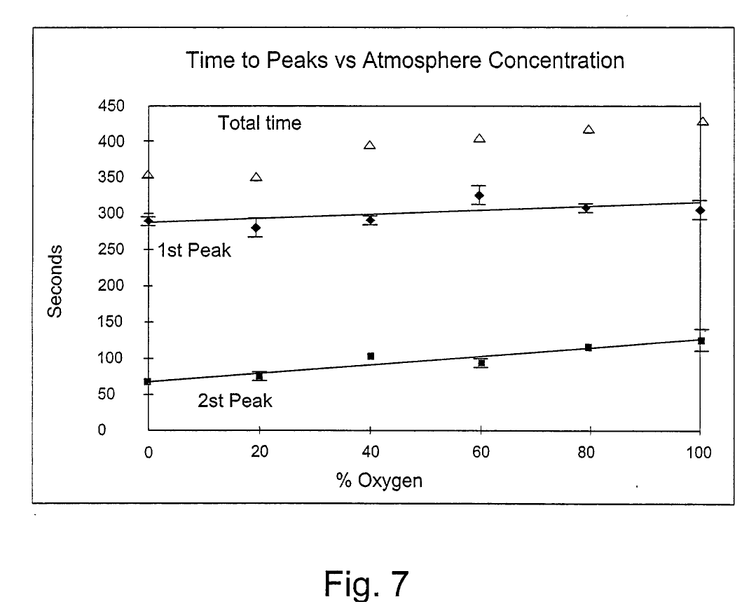

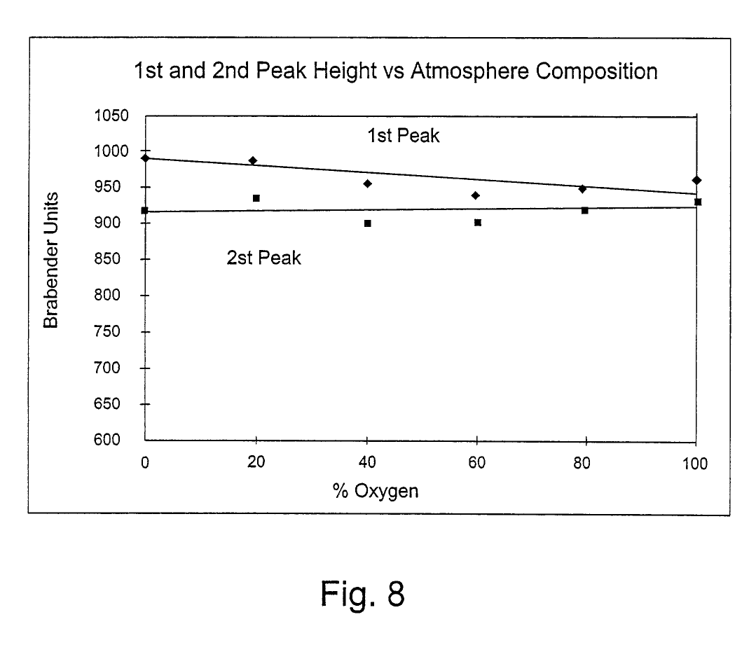

Full farinographs were obtained for each dough. As seen in FIGS. 7 and 8, the dough exhibited an increase in the time to the second peak by roughly 10% for each incremental increase in oxygen concentration. The relationship seemed to be linear and did not follow the logarithmic function seen in the yeast leavened basic bagel dough in FIG. 2. The time to the first peak and the heights of the first and second peak did not show any significant change over the range of atmospheric compositions tested.

This experiment showed that although increased nitrogen concentrations do decrease the time necessary to reach a peak extensibility, the decrease is not as substantial as that seen for yeast leavened doughs.

Mixing Time

After the above experiments, it was determined that the leavening system of the chemically leavened dough would be incompatible with short time scales. Normal handling of the chemically leavened dough allows for a 2-week equilibration period in the packaging. Because the leavening is slow, samples baked soon after mixing did not leaven adequately. To account for this, the encapsulated soda used as the leavening base was replaced with regular unencapsulated soda.

To maintain the same leavening capacity, regular soda was added at 70% of the encapsulated soda weight. The amounts of flour and water were subsequently adjusted to maintain the same ratio. Samples with regular soda and encapsulated soda were both baked immediately out of the mixer, and after a 30 minute rest period. It was found that the dough with regular soda baked immediately out of the mixer produced the largest baked volume of the four combinations. It was therefore determined that regular soda would be used and the samples would be baked immediately out of the mixer. These modifications would still allow study of a chemically leavened system under these conditions.

In light of the above, chemically leavened dough with regular soda was utilized. The doughs were mixed with nitrogen blanketing and without nitrogen blanketing. The conditions used were the same as those used above.

A number of tests were done on these doughs. Upon completion of mixing, the dough was removed from the chamber and two 150 gram samples were cut for extensibility measurements. One of the samples was tested immediately, and one was formed, placed in the rest chamber, and allowed to rest for 15 minutes before being tested. A sample of about 100 grams was cut from each sample and immediately frozen for microscopy. Samples were also tested for gluten matrix formation.

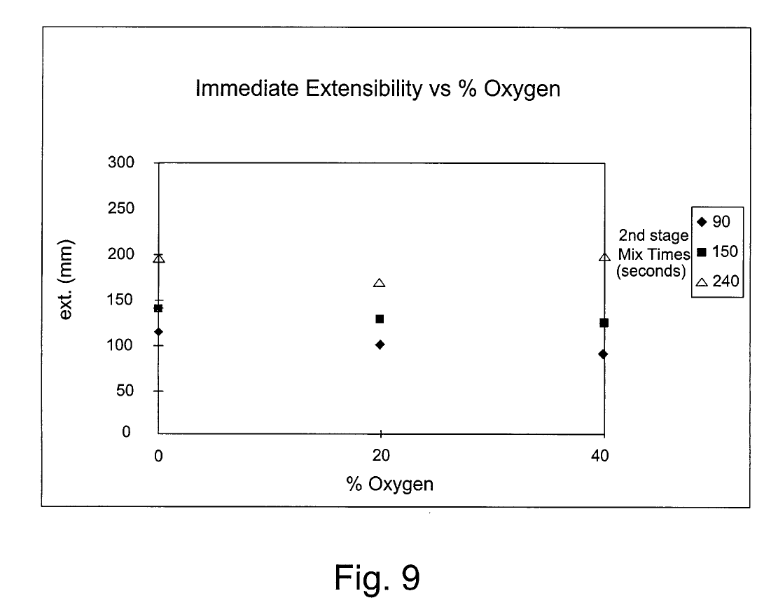

As seen in FIG. 9, the before-peak (90 sec) and to-peak (150 sec) doughs showed linear relationships for immediate extensibility versus oxygen concentrations averaging a ˜10% increase in extensibility with incrementally decreasing oxygen concentration. For the past peak dough (240 sec), both 100% nitrogen and 40% oxygen showed increased immediate extensibility versus air. The dip in immediate extensibility for air is likely noise in the data, and would be found to be a higher value with more runs. There was little change in the immediate extensibility for the before peak (90 sec) and to-peak dough (150 sec). The past peak dough (240 sec), however, exhibited about a 12% decrease in extensibility with increasing oxygen, indicating a degree of softening.

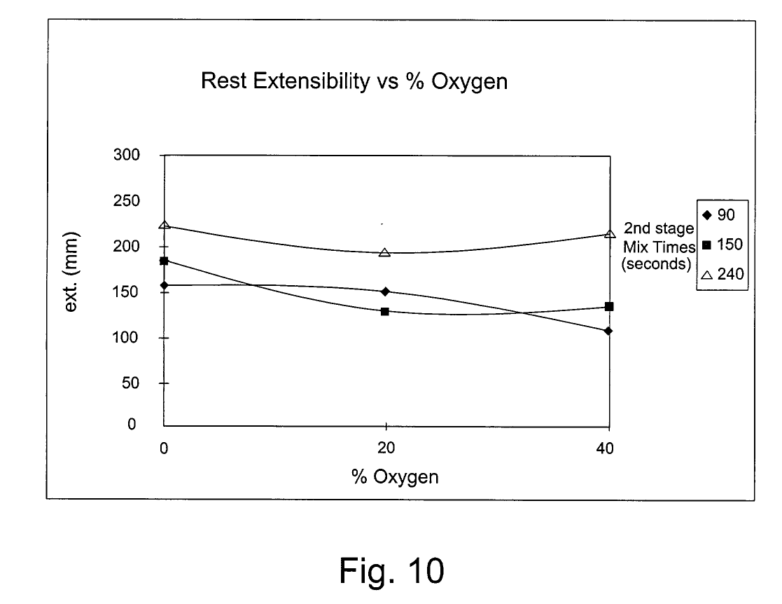

As seen in FIG. 10, rest extensibility for the to-peak (150 sec) and past-peak (240 sec) dough increased significantly for 100% nitrogen compared to air, but also increased (less significantly) for 40% oxygen. The extensibility for air mixed dough in both of the replicated trials seemed to be lower than expected. Although the magnitude of the increase for 100% nitrogen could be caused by noise in the data, there was a reasonable decrease from 100% nitrogen to 40% oxygen (˜25% total) for the to-peak dough (150 sec). This would suggest an approximate change of 10-12% for each increment. For the past-peak dough (240 sec), the high extensibility of the 40% oxygen sample is likely more a function of over-development. The before-peak dough (90 sec) had little change in rest extensibility from nitrogen to air, but showed a significant (25%) drop for 40% oxygen compared to air.

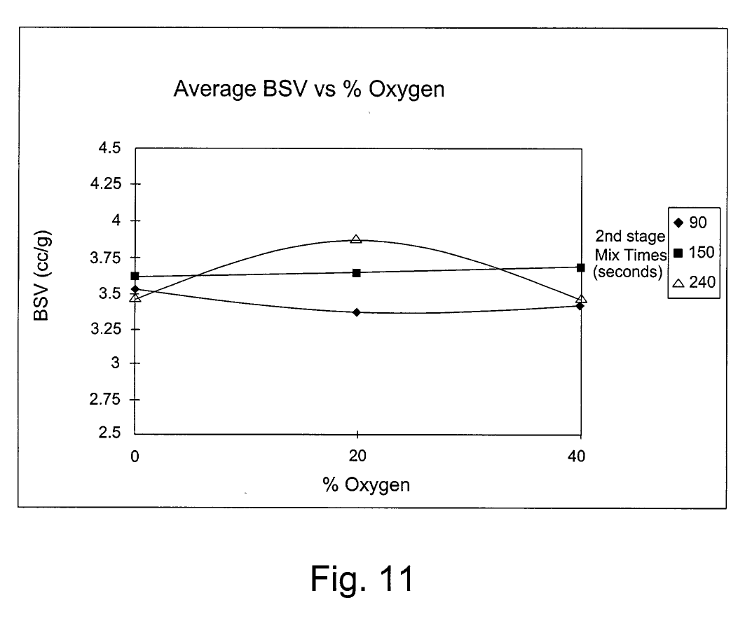

FIG. 11 illustrates the food intermediate as prepared above in which average baked specific volume versus the percent oxygen is shown. The before peak food intermediate or dough (90 sec) shows relatively minor change over the increase in the level of oxygen in the atmosphere, after undergoing a slight decrease in BSV in an air environment. The at peak dough (150 sec) remains relatively constant, that is, there is no loss in the BSV between a 100% nitrogen atmosphere to a ratio of 60:40 nitrogen to oxygen. The after peak dough (240 sec) shows a relatively reciprocal curve from that of the before peak dough, but experiencing a slight increase in BSV during the period of time it is subjected to a normal air atmosphere.

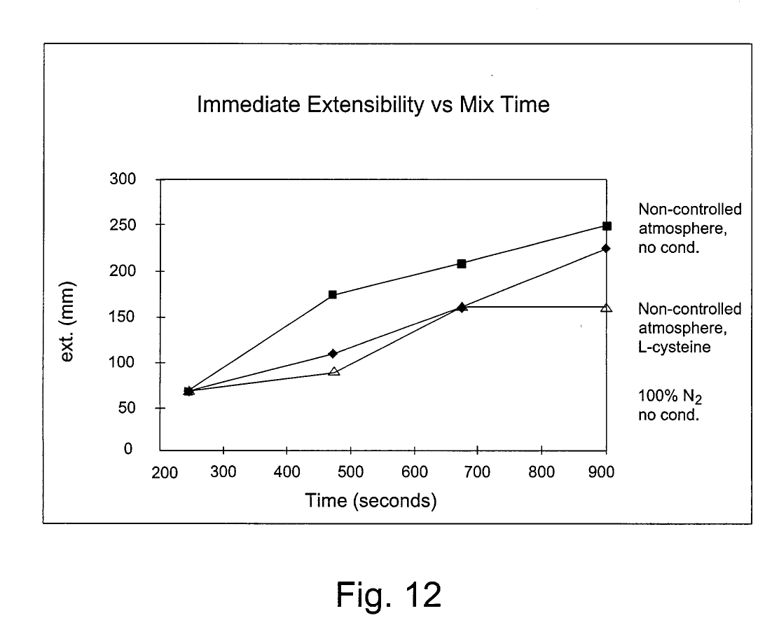

Turning now to FIG. 12 of the present invention, which illustrates the immediate extensibility versus mix time. Here a yeast-leavened dough is provided in a non-controlled atmosphere in which no conditioner is added; a non-controlled atmosphere to which a dough conditioner 1-cysteine has been added; and an atmosphere that has approximately 100% nitrogen, but no conditioner. The graph illustrates that the dough or food intermediate provided in the 100% nitrogen atmosphere reaches the target of 200 mm extensibility at approximately 8 minutes and an extensibility of 250 mm at roughly 15 minutes. The dough using the conditioner only reaches the target extensibility of 200 mm at 15 minutes.

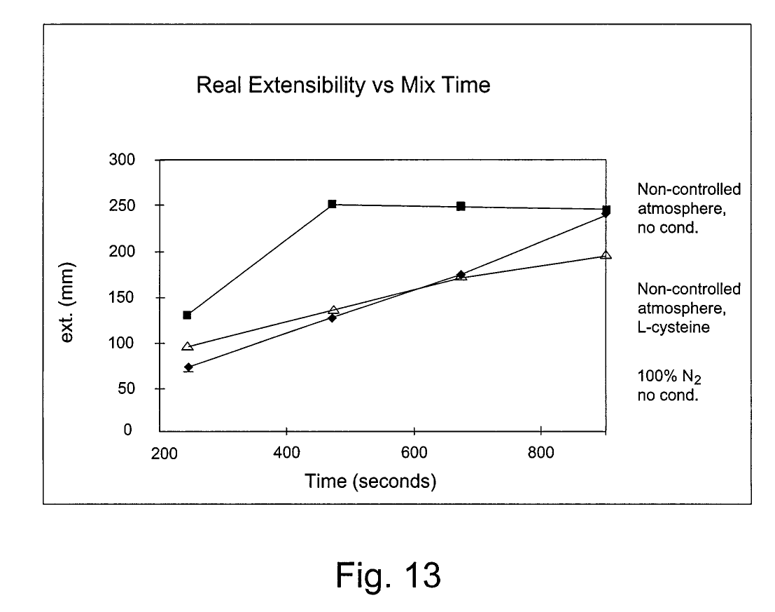

FIG. 13 provides a graph illustrating the extensibility of the dough after a rest versus mix time. Here the dough produced in the 100% nitrogen atmosphere reaches its peak extensibility (250 mm) at roughly 7 minutes whereas the dough using a conditioner reaches its extensibility of approximately 240 mm at 15 minutes. The dough having no conditioner and no treatment achieves an extensibility of 200 mm at 15 minutes.

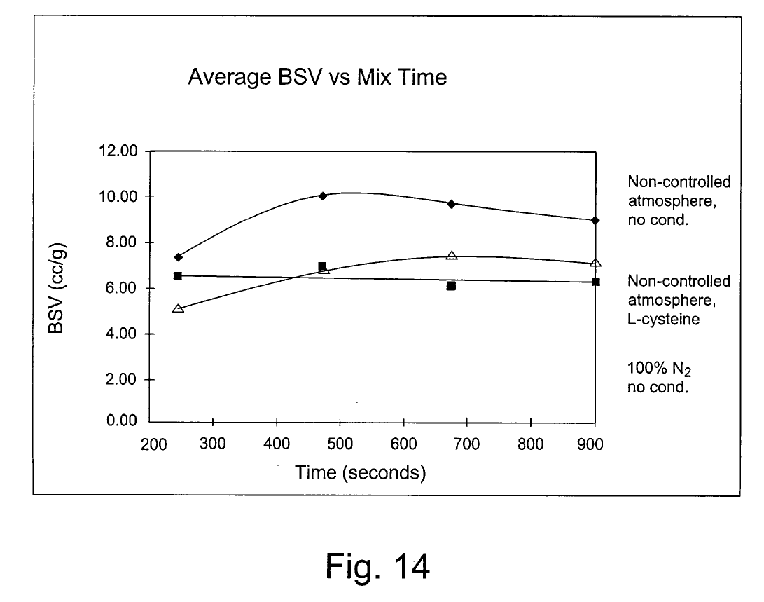

FIG. 14 illustrates the performance of dough as described above and charts the average BSV versus mix time. The dough subjected to the 100% nitrogen atmosphere shows roughly no change in BSV during the mix time. The dough with a conditioner added achieves its highest BSV at roughly 8 minutes and the dough with no conditioner added at roughly 11 minutes.

As the FIGURES clearly illustrate, the subjecting of the dough to a nitrogen rich atmosphere produces a food intermediate that reaches its peak extensibility quicker thereby requiring less mix time and energy without any deleterious effects on dough quality.

It will thus be seen according to the present invention a highly advantageous method of preparing a food intermediate has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

I claim:

1. A method of preparing a food intermediate comprising the steps of:
(a) combining ingredients in a mixing chamber, said mixing chamber being configured such that an atmosphere in said mixing chamber can be created and controlled;
(b) creating the atmosphere in said mixing chamber by adding at least a first gas;
(c) controlling the atmosphere in said mixing chamber to maintain a proportion of said first gas;
(d) blanketing said ingredients in said chamber with said first gas, said first gas making up greater than half of the atmosphere; and
(e) mixing said ingredients in said controlled atmosphere to form a resulting food intermediate having improved processing properties.

2. The method of claim 1, wherein the step of blanketing the ingredients includes at least first and second gases.

3. The method of claim 1, wherein said first gas is nitrogen.

4. The method of claim 2 wherein said second gas is oxygen.

5. The method of claim 1 wherein said first gas comprises approximately 80 percent of said atmosphere.

6. The method of claim 2 wherein said first and second gases are provided in a ratio of approximately 80:20.

7. The method of claim 2, wherein said first and second gases are provided in a ratio of approximately 90:10.

8. The method of claim 1, comprising a further step of purging the atmosphere prior to the step of blanketing the ingredients.

9. The method of claim 1, wherein the step of blanketing includes at least first, second and third gases selected from nitrogen, oxygen, air, helium, neon, argon, carbon dioxide, and combinations thereof.

10. The method of claim 1, wherein the improved processing properties include reduced mix energy and increased extensibility.

11. A method of preparing a food intermediate comprising the steps of:
(a) combining ingredients for a food intermediate in a mixing chamber, said mixing chamber being configured so that an atmosphere therein can be created and controlled;
(b) creating said atmosphere in said mixing chamber by adding at least a first gas and second gas;
(c) controlling said atmosphere in said mixing chamber, said controlled atmosphere including said first gas making up at least 80% of said atmosphere and said second gas making up less than 20% of said atmosphere; and
(d) mixing said ingredients in said controlled atmosphere to form a food intermediate having reduced mix energy requirements.

12. The method of claim 11, including a further step of purging said atmosphere prior to the step of controlling the atmosphere.

13. The method of claim 11, wherein said first gas is nitrogen and said second gas is oxygen.

14. The method of claim 11, wherein said first gas comprises at least about 90% of the controlled atmosphere.

15. The method of claim 11, wherein said first gas comprises at least about 99% of the controlled atmosphere.

16. A method of preparing dough comprising the steps of:
(a) combining ingredients for said dough in a mixing chamber, said mixing chamber having at least a first gas inlet and a gas outlet, and said mixing chamber is configured so that an atmosphere therein can be created and controlled;
(b) purging said atmosphere of said mixing chamber of air;
(c) adding nitrogen to said mixing chamber to create an atmosphere having at least about 80% nitrogen;
(d) blanketing said ingredients with the nitrogen; and
(e) mixing said ingredients in said nitrogen atmosphere to form a resulting dough having increased extensibility.

17. A food intermediate having improved extensibility and mix energy characteristics, comprising;
a set of ingredients including at least flour, water and leavening agents;
an atmosphere having a make up of at least 80% nitrogen; and
wherein said set of ingredients are mixed within said atmosphere to produce a food intermediate having improved extensibility without aid of a food conditioner.
